(19) United States
(12) Patent Application Publication
(10) Pub. No.: US 2026/0151973 A1
(43) Pub. Date: Jun. 4, 2026

(54) METHOD FOR MANUFACTURING OPTICAL COMPONENT

(71) Applicant: TOWA CORPORATION, Kyoto (JP)

(72) Inventors: Hideyuki SAKAI, Kyoto (JP); Hisakazu MOTOMOCHI, Kyoto (JP); Yukitomo TANE, Kyoto (JP)

(73) Assignee: TOWA CORPORATION, Kyoto (JP)

(21) Appl. No.: 19/122,745

(22) PCT Filed: Oct. 18, 2023
(86) PCT No.: PCT/JP2023/037698

§ 371 Date: Apr. 20, 2025

(30) Foreign Application Priority Data
Oct. 24, 2022 (JP) 2022-169884
Apr. 27, 2023 (JP) 2023-072994

(51) Int. Cl. G02B 3/08; G02B 6/32; G02B 6/42; G02B 27/64

(52) U.S. Cl. CPC B29D 11/00375; B29D 11/00384; B29D 11/0049

(57) ABSTRACT

Provided is a method for manufacturing an optical component in which an optical component is manufactured by bonding two or more plates having an optical element part, said method comprising: causing a positioning member to come into contact with a pair of facing surfaces of each first notch part of a first plate, which are opposite each other, said first plate having at least two first notch parts formed along two directions orthogonal to each other; causing the positioning member to come into contact with a pair of facing surfaces of each second notch part of a second plate, which are opposite to each other, said second plate having at least two second notch parts formed along two directions orthogonal to each other; and bonding the first plate and the second plate.

### TECHNICAL FIELD

The invention relates to a technique of a method for manufacturing an optical component.

### RELATED ART

Patent Document 1 discloses an image floating display device including an erect life-size real image optical system formed by two double-sided lens plates; and an image display element positioned at an object-side focal surface of the erect life-size real image optical system. An image resulting from the image display element placed at the position of the object-side focal surface of the erect life-size real image optical system forms an erect life-size spatial image at a position on the image-side focal surface through the erect life-size real image optical system. In this way, it is possible to render an image from the image display element that is visually perceived as if it were floating.

### CITATION LIST

### Patent Document(s)

[Patent Document 1] Japanese U.S. Pat. No. 3,195,249

### SUMMARY OF INVENTION

### Technical Problem

In the erect life-size real image optical system described in Patent Document 1, if misalignment occurs in the optical axes of the lenses formed on the two double-sided lens plates, an accurate spatial image cannot be obtained. Therefore, a technique for precisely aligning the two double-sided lens plates is required.

The invention is made in view of the above-described situation, and an objective is to provide a method for manufacturing an optical component that enables precise alignment between plates.

### Solution to Problem

The objective to be solved by the present invention is as described above, and to solve the problem, a method for manufacturing an optical component according to the invention is provided to manufacture the optical component by bonding two or more plates. The plate has an optical element part. The method includes: a first positioning step for causing a positioning member to come into contact with a pair of facing surfaces of each first notch part of a first plate, which face each other, the first plate having at least two first notch parts formed along two directions orthogonal to each other; a second positioning step for causing the positioning member to come into contact with a pair of facing surfaces of each second notch part of a second plate, which face each other, the second plate having at least two second notch parts formed along two directions orthogonal to each other; and a bonding step for bonding the first plate and the second plate.

### Effects of Invention

According to the invention, precise alignment between plates can be achieved.

### BRIEF DESCRIPTION OF DRAWINGS

(a) of FIG. 1 is a plan view showing an example of an optical component, and (b) of FIG. 1 is an enlarged side view showing an example of the optical component.

(a) of FIG. 2 is a side cross-sectional view showing an example of a molding die, and (b) of FIG. 2 is a plan view showing a lower mold.

FIG. 3 is a perspective view showing an assembly jig.

FIG. 4 is a perspective view showing a state where a lower plate is placed on the assembly jig.

FIG. 5 is a plan view showing a state where a positioning member is inserted into a notch part of the lower plate.

FIG. 6 is a perspective view showing the state where the positioning member is inserted into the notch part of the lower plate.

FIG. 7 is a perspective view showing a state where a positioning member is inserted into a notch part of an upper plate.

FIG. 8 is a perspective view showing a state where a clamp plate is placed on the upper plate.

FIG. 9 is a flowchart showing an example of a method for manufacturing an optical member.

FIG. 10 is a plan view showing a plate according to a second embodiment.

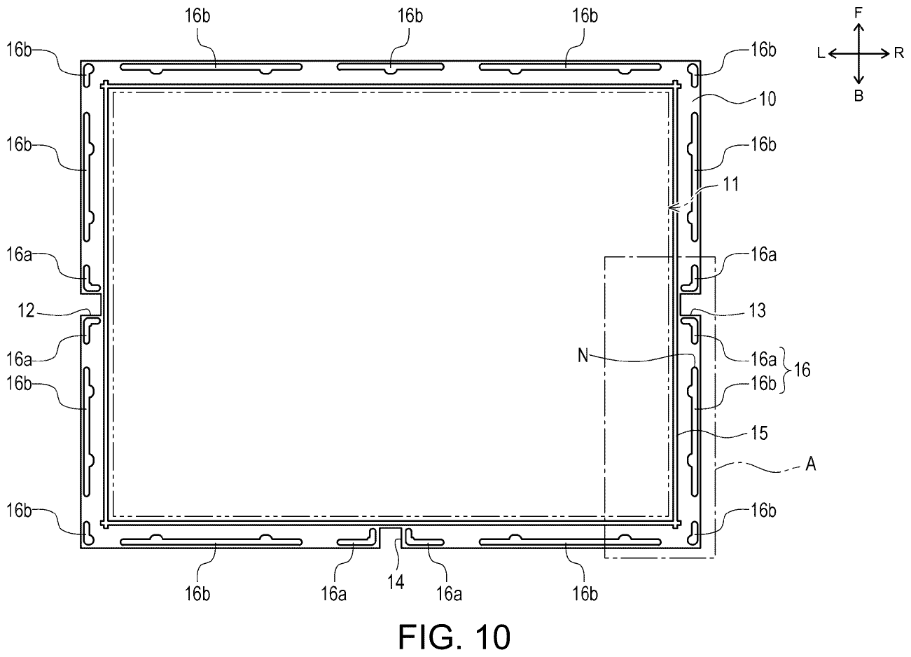

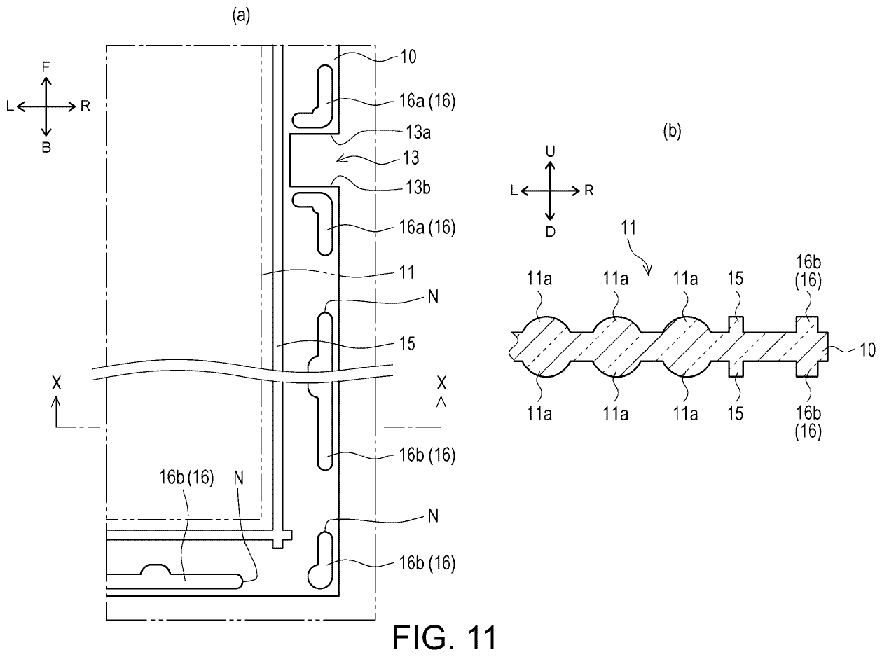

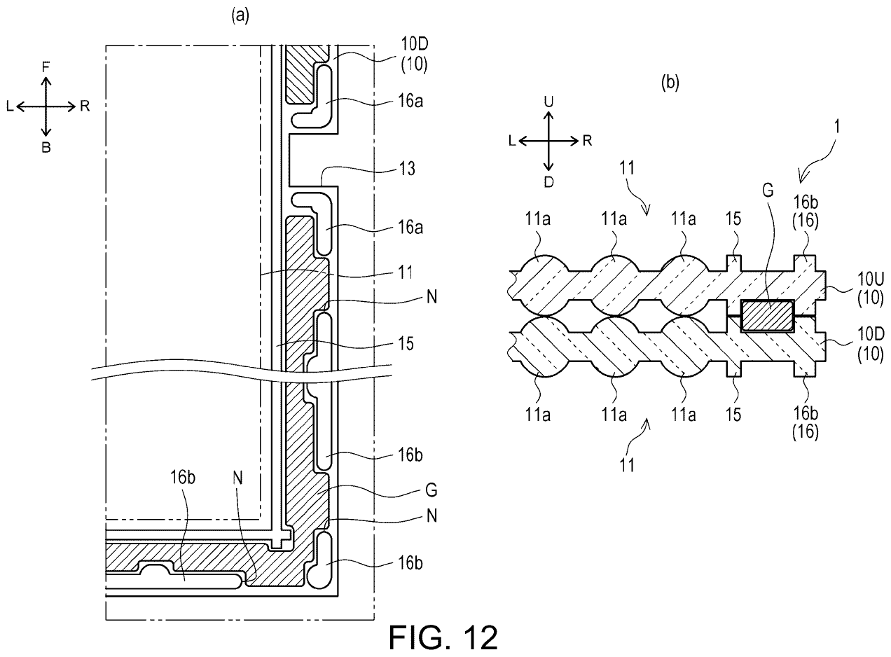

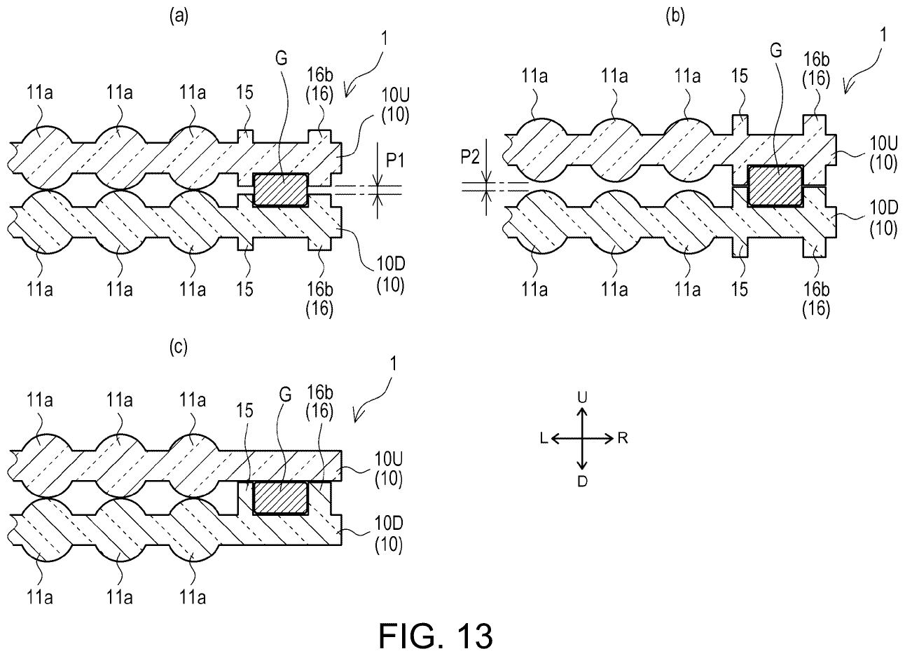

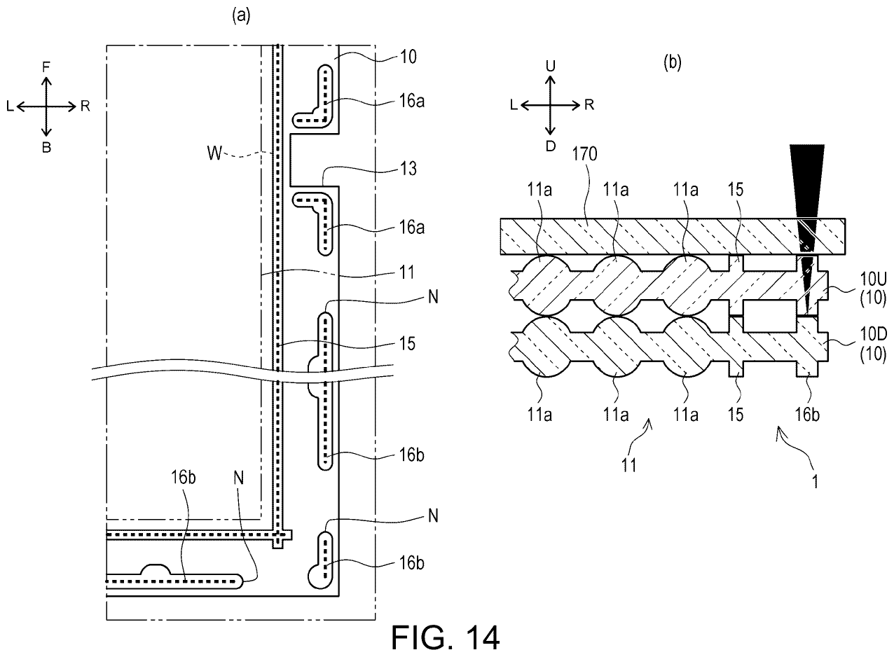

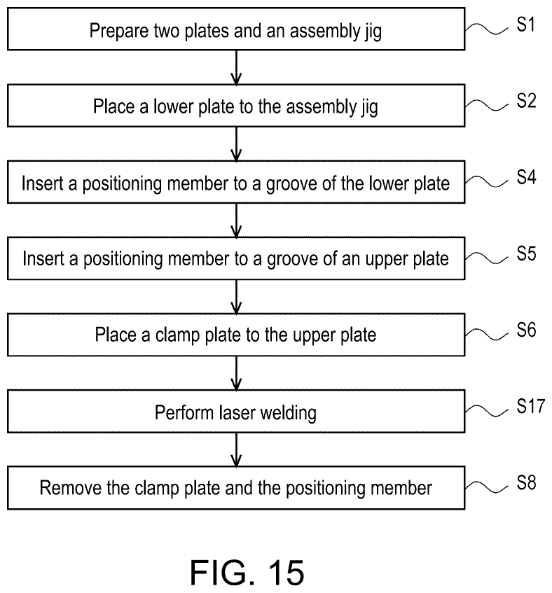

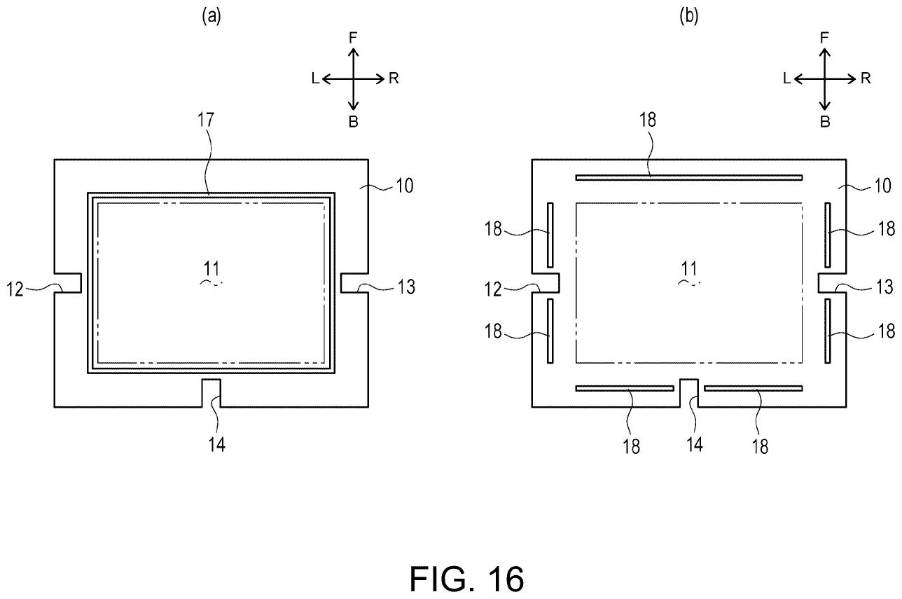

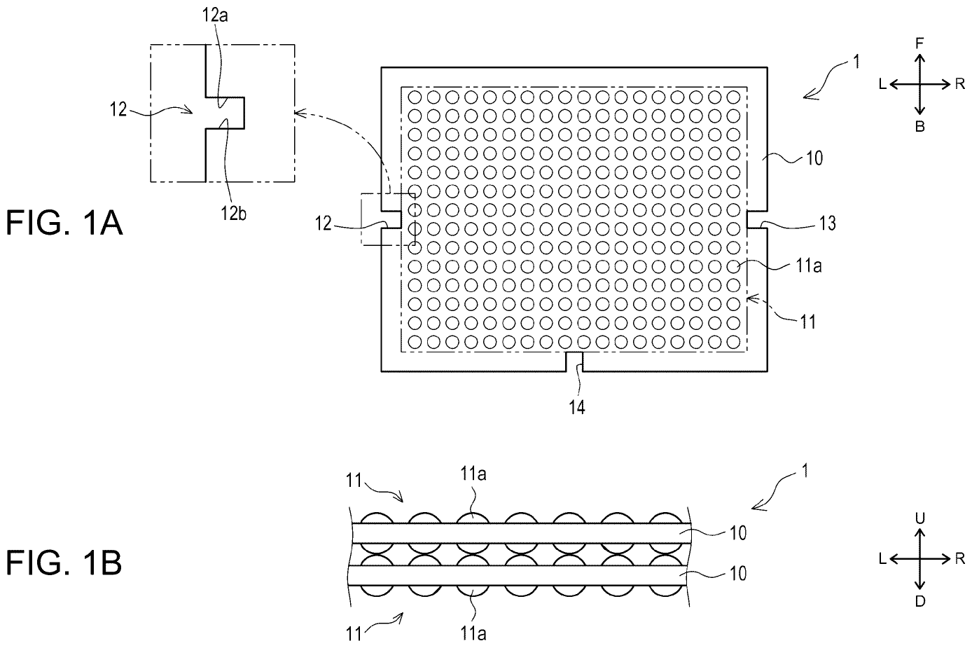

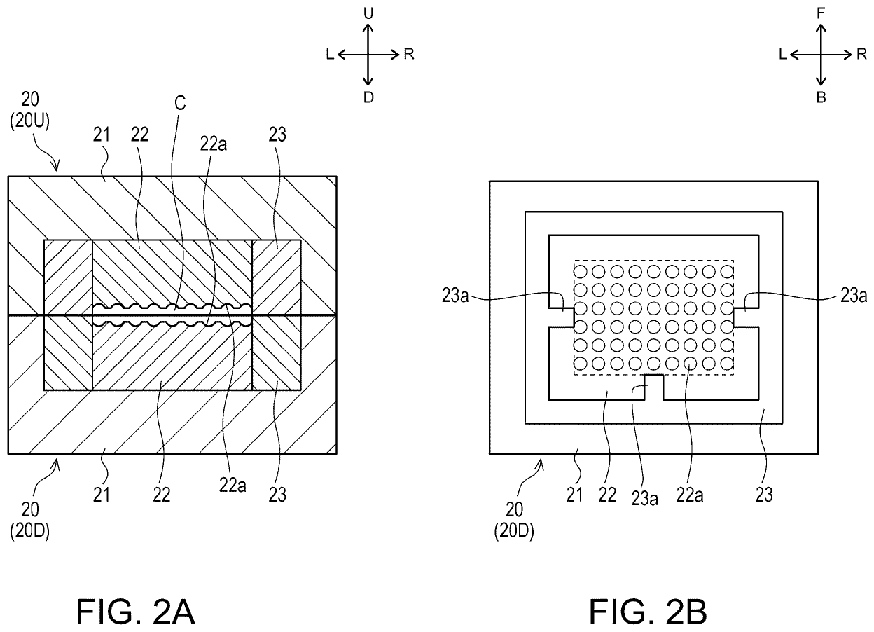

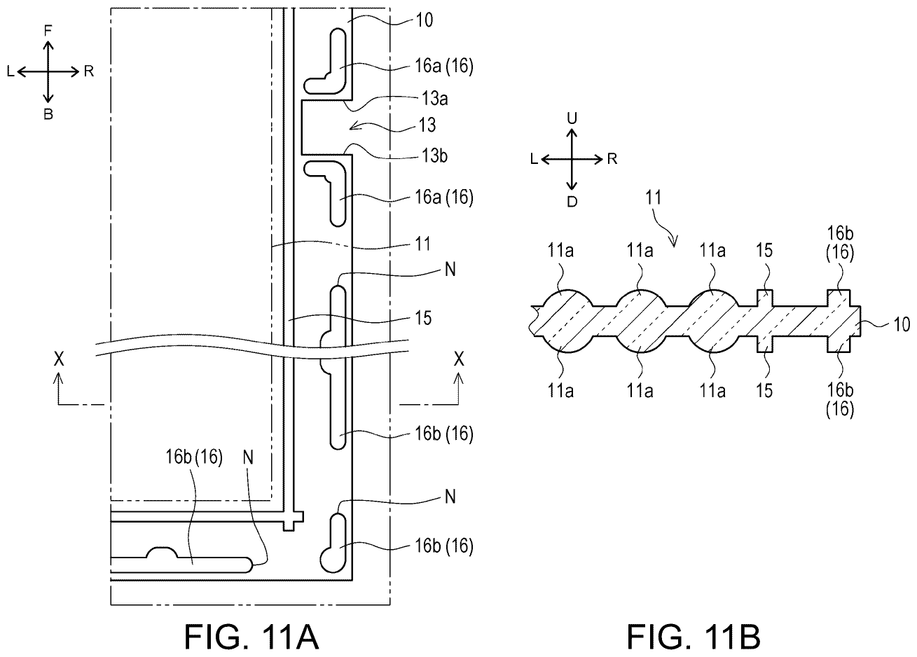

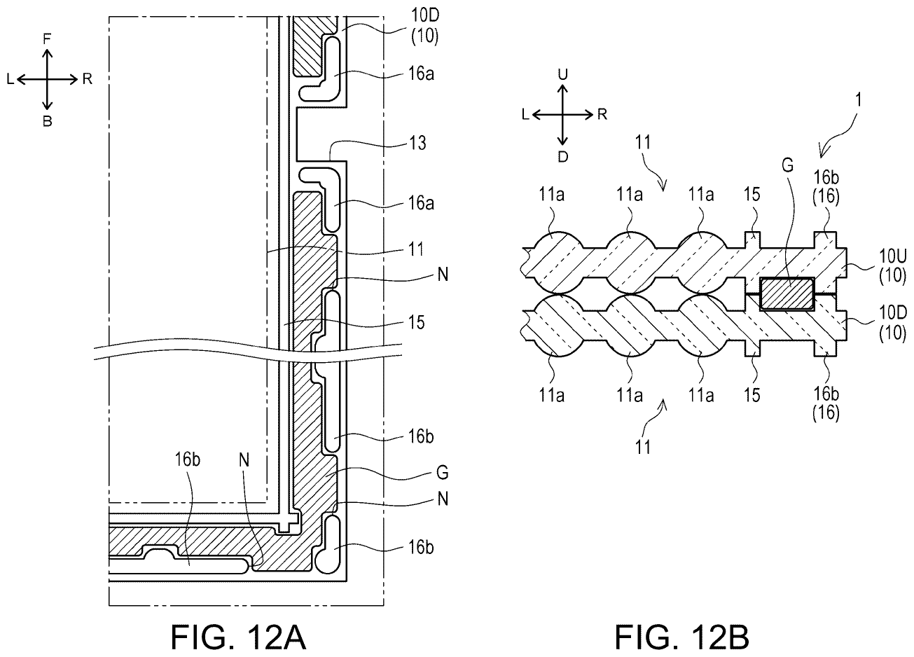

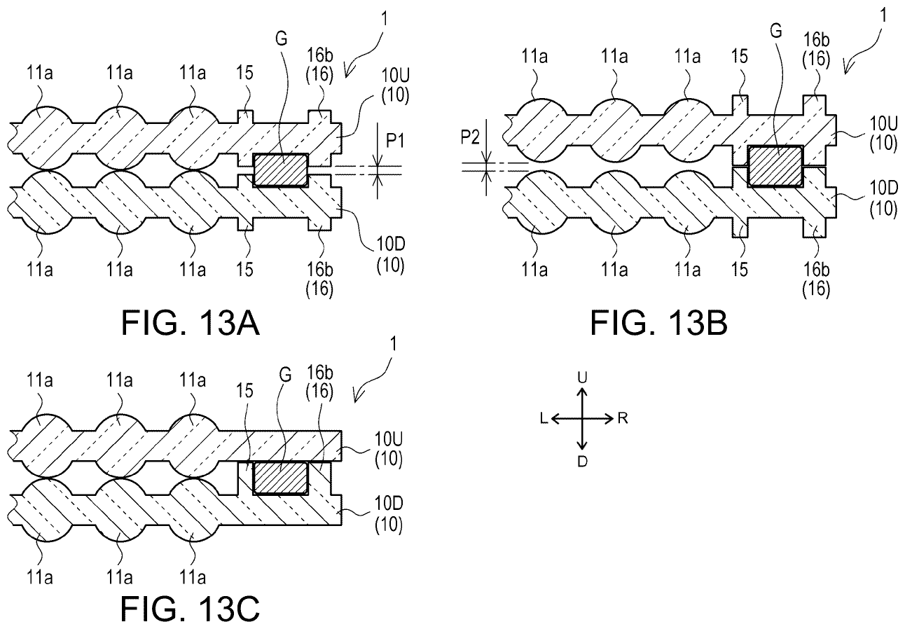

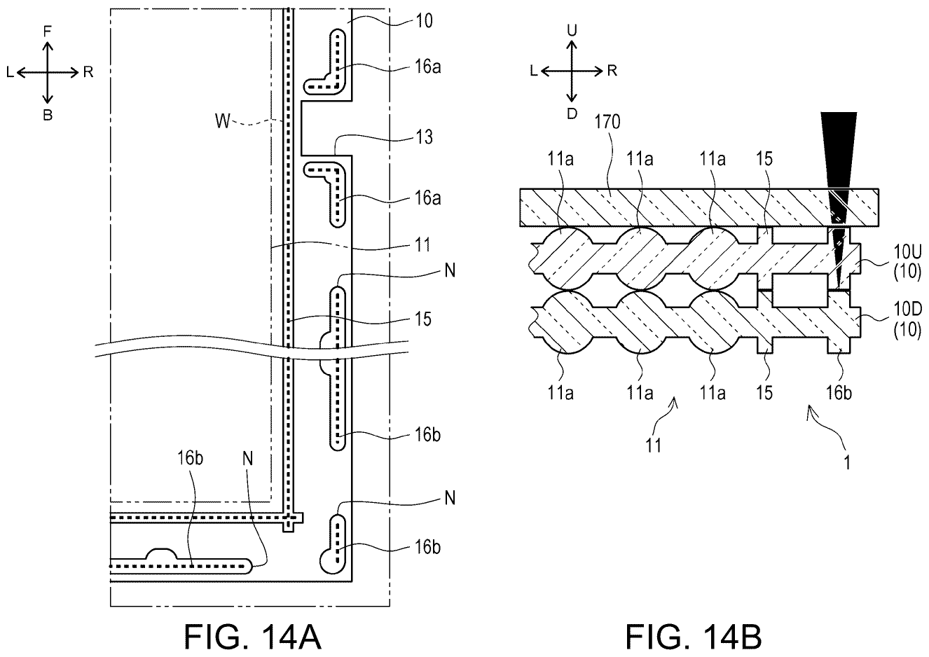

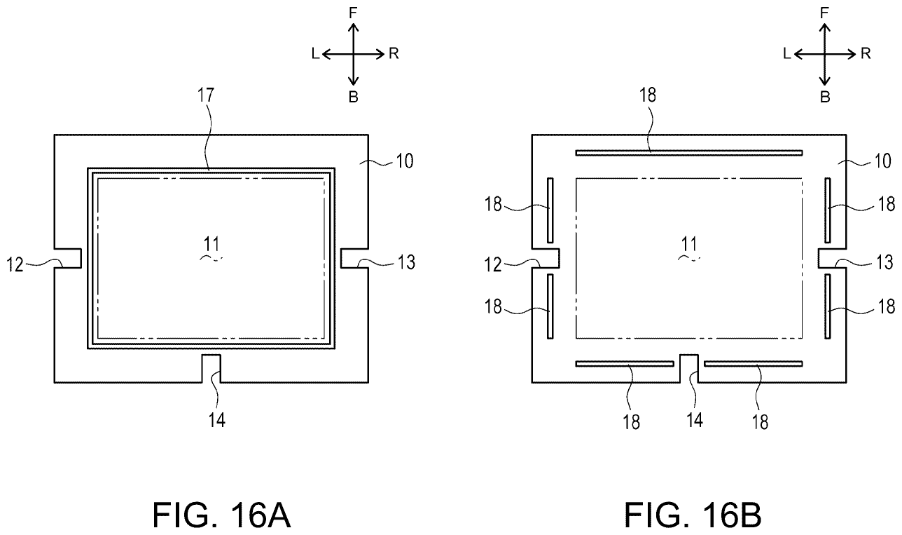

(a) of FIG. 11 is an enlarged view of a part A in FIG. 10, and (b) of FIG. 11 is a cross-sectional view along X-X.

(a) of FIG. 12 is an enlarged plan view showing a lower plate to which an adhesive is applied, and (b) of FIG. 12 is a front cross-sectional view showing a state where an upper plate is placed on the lower plate to which the adhesive is applied.

(a) of FIG. 13 is a front cross-sectional view showing an optical component according to a first modified example, (b) of FIG. 13 is a front cross-sectional view showing an optical component according to a second modified example, and (c) of FIG. 13 is a front cross-sectional view showing an optical component according to a third modified example.

(a) of FIG. 14 is an enlarged plan view showing a plate according to a third embodiment, and (b) of FIG. 14 is a front cross-sectional view showing a state where laser is irradiated on the plate according to the third embodiment.

FIG. 15 is a flowchart showing an example of a method for manufacturing an optical member according to the third embodiment.

(a) of FIG. 16 is a schematic plan view showing a plate according to a fourth modified example, and (b) of FIG. 16 is a schematic plan view showing a plate according to a fifth modified example.

### DESCRIPTION OF EMBODIMENTS

In the following description, the directions indicated by arrows U, D, L, R, F, and B in the figures are defined as the upward direction, downward direction, left direction, right direction, forward direction, and backward direction, respectively. For the ease of description, the shapes, arrangements, dimensions, etc., of each member in the drawings may be exaggerated as appropriate.

### Optical Component 1

First, with reference to FIG. 1, an optical component 1 manufactured according to the manufacturing method of the embodiment (first embodiment) will be described.

The optical component 1 according to the embodiment allows a user to perceive an image floating above a display device by focusing the image displayed on a display device, such as a monitor, at a focal position. The optical component 1 includes two plates 10.

The plate 10 is a microlens array that includes an optical element part 11 where minute lenses 11a are continuously arranged. The plate 10 is formed in a rectangular plate shape. The optical element part 11 is set over a rectangular range excluding the outer periphery of the plate 10. On both surfaces of the optical element part 11, numerous convex lenses 11a are formed to be aligned vertically and horizontally. All of the lenses 11a are formed in the same shape (in the illustrated example, hemispherical). The lenses 11a on both surfaces of the plate 10 are formed that the optical axes thereof coincide with each other.

In the peripheral portion of the plate 10 (outer side of the optical element part 11), notch parts (a left notch part 12, a right notch part 13, and a rear notch part 14) are formed for positioning. The notch parts (the left notch part 12, the right notch part 13, and the rear notch part 14) are formed on a side surface of the rectangular plate 10 and two side surfaces adjacent to the side surface. The left notch part 12 and the right notch part 13 are formed on the left and right side parts of the plate 10, respectively, as shown in (a) of FIG. 1. The left notch part 12 and the right notch part 13 are formed to extend along the left-right direction. The left notch part 12 and the right notch part 13 are positioned at the center of the width of the plate 10 in the front-rear direction. The rear notch part 14 is formed on the rear side part of the plate 10 as shown in (a) of FIG. 1. The rear notch part 14 is formed to extend along the front-rear direction. In other words, the rear notch part 14 is formed along a direction perpendicular to a direction in which the left notch part 12 and the right notch part 13 extend. The rear notch part 14 is positioned at the center of the width of the plate 10 in the left-right direction. In the embodiment, since each notch part is formed in substantially the same shape, the following description will focus on the left notch part 12 in more detail.

The left notch part 12 is formed to extend rightward from the left side part of the plate 10 by notching the left side part of the plate 10 inward (rightward). The left notch part 12 does not necessarily need to be formed by notching. Regardless of how the notch is formed, it suffices as long as a portion of the plate 10 is a portion having a notch shape. In the left notch part 12, a pair of surfaces (facing surfaces) 12a and 12b that face each other in the front-rear direction are formed. The pair of facing surfaces 12a and 12b are formed to extend linearly in the left-right direction. Accordingly, the left notch part 12 is formed to have a constant width in the front-rear direction. Hereafter, the direction in which the pair of facing surfaces 12a and 12b extend (the left-right direction in (a) of FIG. 1) will be referred to as the vertical direction of the left notch part 12, and the direction perpendicular to the pair of facing surfaces 12a and 12b (the front-rear direction in (a) of FIG. 1) will be referred to as the width direction of the left notch part 12.

The right notch part 13 and the rear notch part 14 are formed in substantially the same shape as the left notch part 12. As a result, the right notch part 13 has a pair of facing surfaces that face each other in the front-rear direction. Additionally, the rear notch part 14 has a pair of facing surfaces that face each other in the left-right direction.

In this way, the left notch part 12 and the right notch part 13 each have a pair of facing surfaces that extend linearly in the left-right direction. Additionally, the rear notch part 14 has a pair of facing surfaces that extend linearly in the front-rear direction. In other words, the facing surfaces of the rear notch part 14 are formed to extend in a direction perpendicular to the facing surfaces of the left notch part 12 and the right notch part 13.

Among the two plates 10 used in the optical component 1, each notch part of a lower plate 10D, which will be described later, serves as an implementation of the first notch part of the invention. Additionally, each notch part of the upper plate 10U, which will be described later, is an implementation of the second notch part of the invention.

The dimensions of the plate 10 according to the embodiment are not particularly limited, but are assumed to be approximately 100 mm to 140 mm in the vertical direction and 130 mm to 200 mm in the horizontal direction. The thickness of the plate 10 is not particularly limited, but is assumed to be approximately 0.5 mm to 2 mm. Additionally, the dimensions of each notch part formed in the plate 10 are not particularly limited, but are assumed to be approximately 3 mm to 9 mm in length in the vertical direction (depth of the notch part) and 2 to 8 mm in width.

The plate 10 according to the embodiment is formed to exhibit a shape in left-right symmetry. Therefore, it is possible to use (manufacture the optical component 1) the plate 10 by inverting the front and back surfaces.

The optical component 1 is formed by bonding two plates 10, which are formed as described above, with the surfaces thereof being aligned to each other (refer to (b) of FIG. 1). At this time, it is necessary to accurately align the relative positions of the two plates 10. In the embodiment, it is necessary to align the optical axis of the lens 11a of one of the plates 10 with the optical axis of the lens 11a of the other plate 10.

### Molding Die 20

The plate 10 is manufactured by resin molding. The following describes the molding die 20 for molding the plate 10.

The molding die 20 shown in FIG. 2 is for manufacturing the plate 10 by injection molding. The molding die 20 mainly includes a lower die 20D and an upper die 20U. Since the lower die 20D and the upper die 20U have generally similar structures, the following describes the structure of the lower die 20D.

The lower die 20D mainly includes a base part 21, a cavity block 22, and a side block 23.

The base part 21 is a portion where the cavity block 22 and the side block 23, which will be described later, are placed. On the upper surface of the base part 21, a concave part is formed for placing the cavity block 22 and other components.

The cavity block 22 forms a cavity C with a shape corresponding to the resin molded product (plate 10). A molding part 22a is formed in the cavity block 22.

The molding part 22a is a surface (resin molding surface) facing a cavity C to shape the resin molded product into a predetermined shape. The molding part 22a is formed on the upper surface of the cavity block 22. The molding part 22a has a shape corresponding to the shape of the lens 11a of the plate 10 (a shape in which hemispherical concave parts are aligned).

The side block 23 forms the side part of the cavity C. The side block 23 is formed in a frame shape when viewed in a plan view. Specifically, the side block 23 has a through-hole in a central part when viewed in a plan view, where the cavity block 22 can be placed. A protrusion part 23a is formed on the side block 23.

The protrusion part 23a is a portion that protrudes toward the inner side of the side block 23. The protrusion part 23a has a shape corresponding to each notch part (the left notch part 12, the right notch part 13, and the rear notch part 14) of the plate 10.

The side block 23 is placed in the concave part of the base part 21, and the cavity block 22 is further disposed on the inner side of the side block 23.

The upper mold 20U has a structure substantially similar to that of the lower mold 20D (configured by inverting the lower mold 20D vertically). Therefore, for each component of the upper mold 20U, the description is omitted by assigning the same reference numerals as the corresponding components of the lower mold 20D.

By placing the lower mold 20D and the upper mold 20U facing each other vertically, the cavity C corresponding to the plate 10 is formed. Additionally, a runner part, a gate part, etc., (not shown) are formed in the molding die 20 to guide the resin into the cavity C.

The plate 10 is manufactured by injection molding using the molding die 20 configured as described above. Since the two plates 10 forming the optical component 1 are manufactured using the same molding die 20, the plates 10 have identical shapes.

### Assembly Jig 100

The optical component 1 can be manufactured by bonding two plates 10 manufactured as described above to each other. The following describes the assembly jig 100 used at the time of bonding the two plates 10 together.

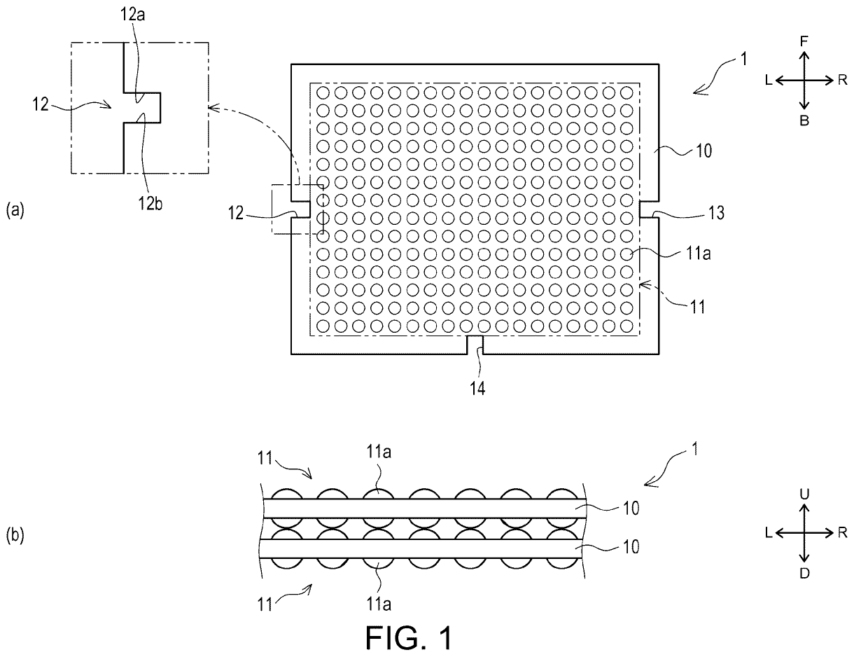

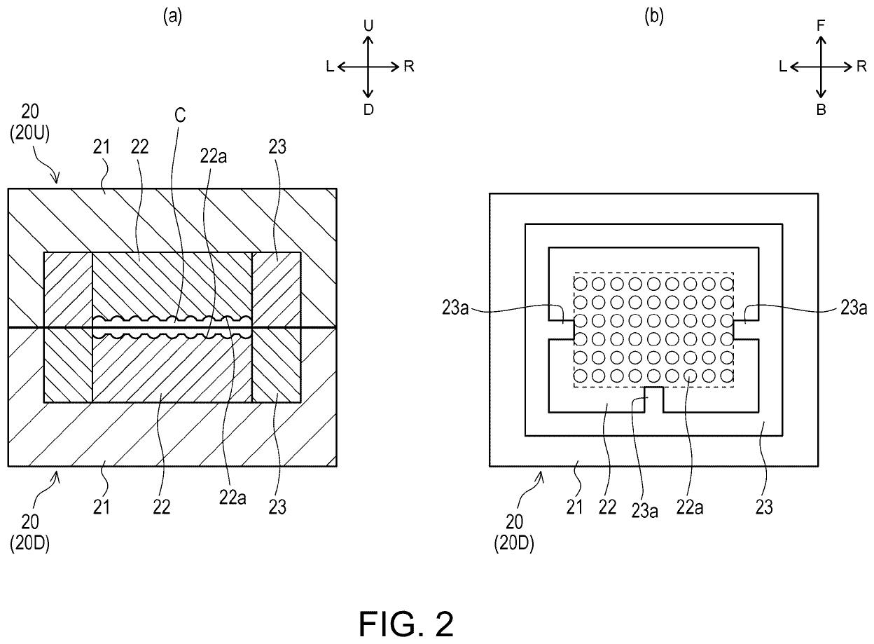

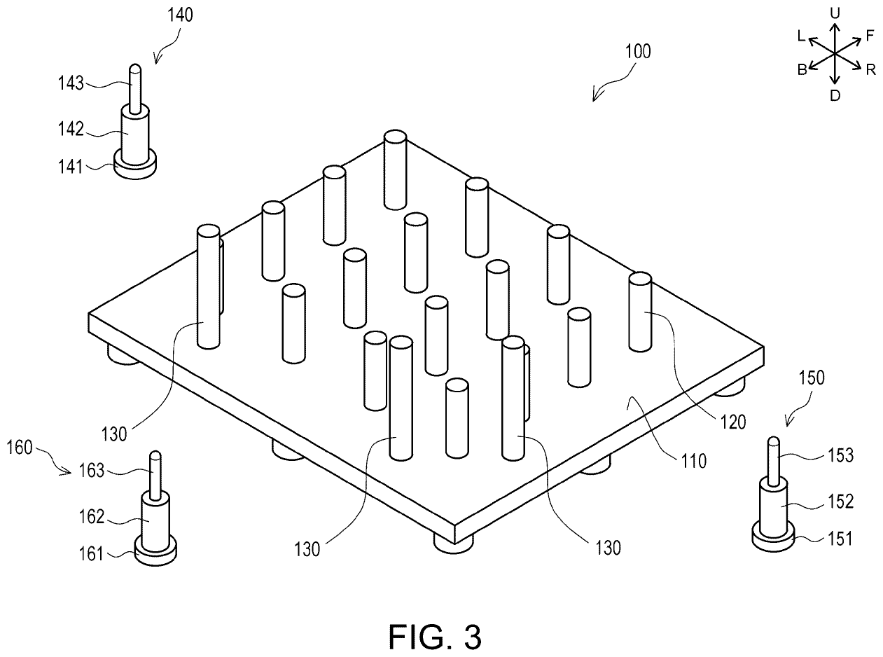

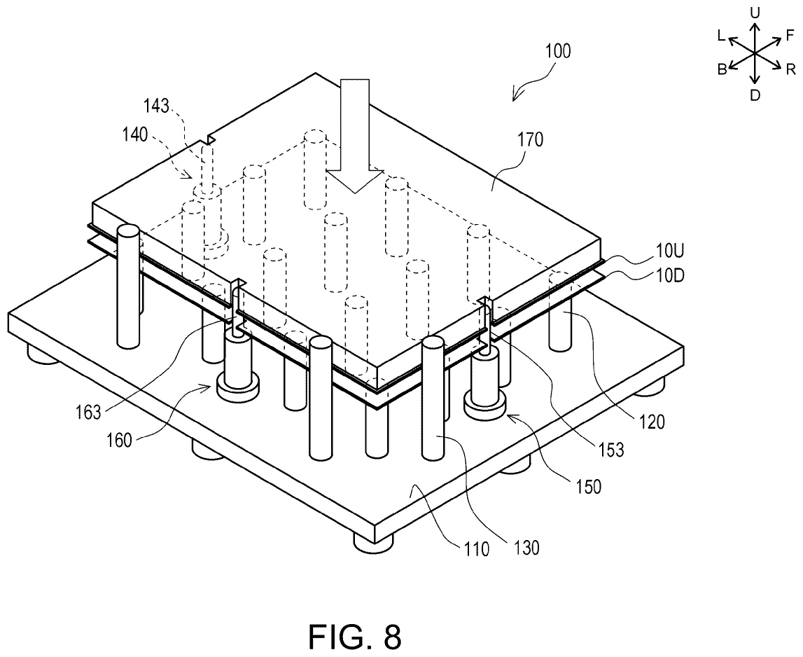

The assembly jig 100 shown in FIG. 3 mainly includes a base part 110, short pillars 120, long pillars 130, a first positioning member 140, a second positioning member 150, a third positioning member 160, and a clamp plate 170 (see FIG. 8).

The base part 110 is for supporting the short pillars 120 and the long pillars 130, which will be described later. The base part 110 is formed in a rectangular plate shape.

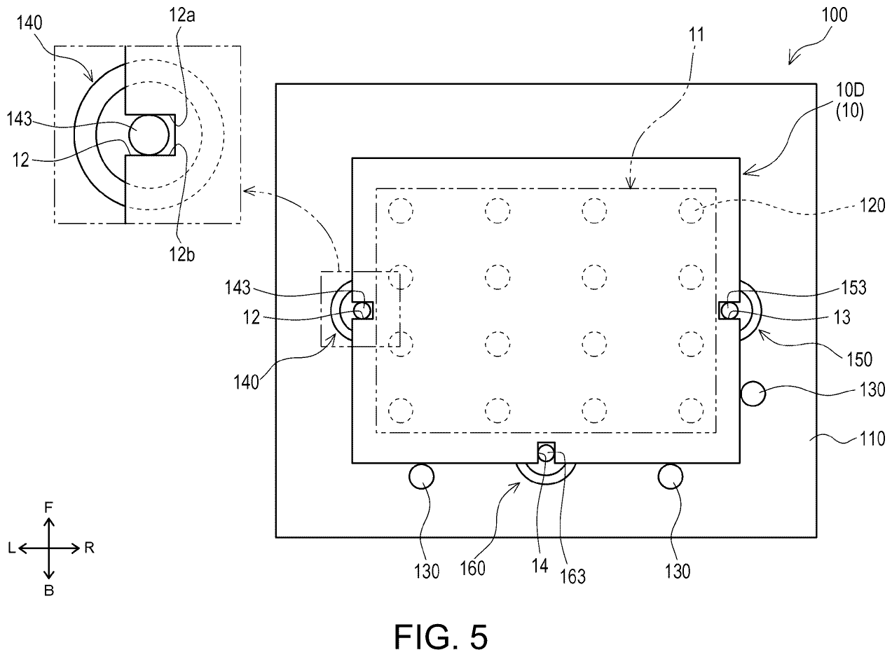

The short pillars 120 shown in FIG. 3 and FIG. 5 are provided for supporting the plate 10 from below. The short pillars 120 are formed in a cylindrically columnar shape. The short pillars 120 are fixed to the upper surface of the base part 110 with the axes oriented in the upper-lower direction. As a result, the short pillars 120 are arranged to protrude upward from the base part 110. The upper end surfaces of the short pillars 120 are formed to be planar.

Multiple short pillars 120 are provided on the base part 110. The lengths (height from the upper surface of the base part 110 to the upper end of the short pillar 120) of the short pillars 120 are formed to be identical. The short pillars 120 are arranged with appropriate spacing in both the front-rear direction and the left-right direction. In the illustrated example, the short pillars 120 are arranged in 4 rows in the front-rear direction and 4 rows in the left-right direction. As shown in FIG. 5, in a plan view, the short pillars 120 are arranged to fit within the range corresponding to the optical element part 11 of the plate 10. The short pillars 120 serve as an example of the first pillars of the invention.

The long pillars 130 shown in FIG. 3 and FIG. 5 are for roughly positioning the plate 10 supported by the short pillars 120. The long pillars 130 are formed in a cylindrically columnar shape. The long pillars 130 are fixed to the upper surface of the base part 110 with the axes oriented in the upper-lower direction. As a result, the long pillars 130 are arranged to protrude upward from the base part 110.

Multiple (in the embodiment, three) long pillars 130 are provided on the base part 110. The lengths (height from the upper surface of the base part 110 to the upper end of the long pillar 130) of the long pillars 130 are formed to be longer than the length of the short pillar 120. As shown in FIG. 5, among the three long pillars 130, two long pillars 130 are disposed in left-right arrangement behind the short pillars 120. Among the three long pillars 130, the remaining long pillar 130 is arranged to the right of the short pillars 120. By bringing the three long pillars 130 into contact with the rear end surface and the right end surface of the plate 10 respectively, the positioning of the plate 10 supported by the short pillars 120 can be performed. The long pillars 130 serve an example implementation of the second pillars of the invention.

The first positioning member 140 shown in FIG. 3 and FIG. 5 is provided for positioning of the plate 10 by contacting the left notch part 12 of the plate 10. The first positioning member 140 mainly includes a bottom part 141, a cylindrically columnar part 142, and a contact part 143.

The bottom part 141 forms the lower portion of the first positioning member 140. The bottom part 141 is formed in a circular plate shape.

The cylindrically columnar part 142 is a portion formed to protrude upward from the bottom part 141. The cylindrically columnar part 142 is formed on the upper surface of the bottom part 141 with the axis oriented in the upper-lower direction.

The contact part 143 is a cylindrical portion that contacts the plate 10. The contact part 143 is formed by applying processing (such as cutting) to the upper end of the cylindrically columnar part 142 to achieve a desired diameter. The diameter of the contact part 143 is formed to correspond to the width of the left notch part 12 of the plate 10 (the distance between the facing surfaces 12a and 12b). Specifically, the width of the left notch part 12 of the plate 10 in the front-rear direction, which manufactured by using the molding die 20, is measured, and the diameter of the contact part 143 is decided so that the contact part 143 makes point contact with each of the facing surfaces 12a and 12b of the left notch part 12. In the embodiment, the diameter of the contact part 143 is adjusted so that the clearance between the left notch part 12 and the contact part 143 is 3 μm or less. In this way, by processing (custom fitting) the contact part 143 to have a diameter that matches the actual left notch part 12 of the plate 10, the plate 10 can be positioned accurately.

The second positioning member 150 is provided for positioning the plate 10 by contacting the right notch part 13 of the plate 10. The second positioning member 150 mainly includes a bottom part 151, a cylindrically columnar part 152, and a contact part 153. The diameter of the contact part 153 is formed to correspond to the width of the right notch part 13 of the plate 10. Other configurations of the second positioning member 150 are similar to those of the first positioning member 140, so detailed description is omitted.

The third positioning member 160 is provided for positioning the plate 10 by contacting the rear notch part 14 of the plate 10. The third positioning member 160 mainly includes a bottom part 161, a cylindrically columnar part 162, and a contact part 163. The diameter of the contact part 163 is formed to correspond to the width of the rear notch part 14 of the plate 10. Other configurations of the third positioning member 160 are similar to those of the first positioning member 140, so detailed description is omitted.

The clamp plate 170 shown in FIG. 8 has a weight for applying a load when two plates 10 are bonded. The clamp plate 170 is formed in a plate shape that is either in the same size as the plate 10 or slightly smaller than the plate 10. It is desirable that the clamp plate 170 is formed in a shape that can cover at least the optical element part 11 to easily correct the warpage of the optical element part 11 formed on the plate 10. The clamp plate 170 is formed with a weight sufficient to correct the warpage of the two plates 10. The clamp plate 170 is an example of the weight in the invention.

### Method for Manufacturing the Optical Component 1

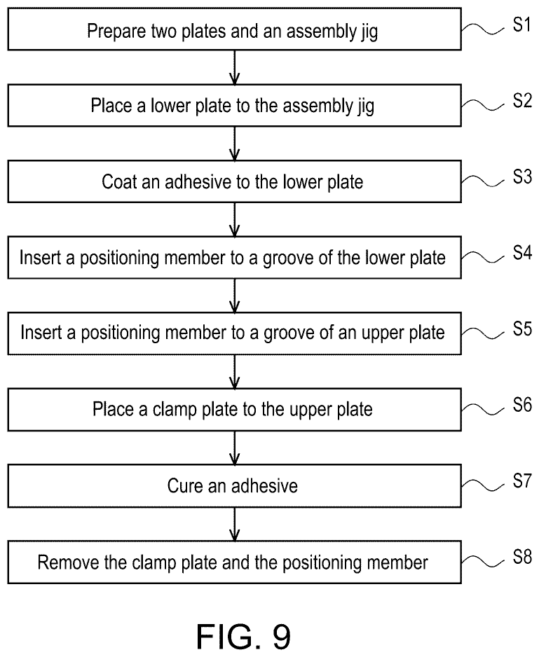

The following describes the method for manufacturing the optical component 1 (method for bonding the two plates 10) by using the assembly jig 100 configured as described above. FIG. 9 shows a flowchart illustrating a method for manufacturing the optical component 1. In the following description, to distinguish between the two plates 10, the two plates 10 may be referred to as the lower plate 10D and the upper plate 10U, respectively. The lower plate 10D and the upper plate 10U are examples of the first plate and the second plate in the invention, respectively.

Firstly, the two plates 10 and the assembly jig 100 as described above are prepared (Step S1 in FIG. 9). The two plates 10 are manufactured by injection molding by using the molding die 20. Additionally, the diameter of the contact part 143 (see to FIG. 5) of the first positioning member 140 of the assembly jig 100 is processed to correspond to the width of the left notch part 12 of the plate 10 manufactured by the molding die 20. Similarly, the second positioning member 150 and the third positioning member 160 are also processed so that the diameters correspond to the widths of the right notch part 13 and the rear notch part 14, respectively.

In the case where the optical components 1 are manufactured repeatedly, the adjustment of the diameter of the contact part of each positioning member (for example, the contact part 143 of the first positioning member 140) may be be done only once at the beginning. For instance, since the shapes of the plates 10 manufactured by using the same molding die 20 are considered to be identical, by adjusting the diameter of the contact part of each positioning member only once at the beginning, the workload can be reduced. However, in the case where the plates 10 from different lots are used or plates 10 manufactured with different molding parts 20 are used, it is desirable to re-adjust the diameter of the contact part of each positioning member.

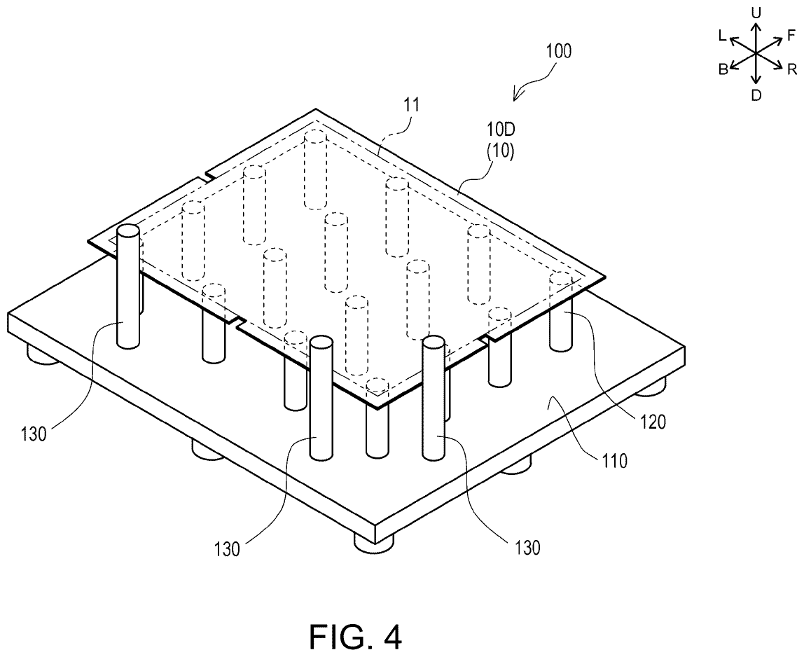

Next, the lower plate 10D is disposed on the assembly jig 100 (Step S2 in FIG. 9). Specifically, as shown in FIG. 4 and FIG. 5, the lower plate 10D is placed on the short pillars 120. In the state, the rear end surface and the right end surface of the lower plate 10D are brought into contact with the long pillars 130. Accordingly, rough positioning of the lower plate 10D on the short pillars 120 can be performed.

At this time, the short pillars 120 support the optical element part 11 of the lower plate 10D from below. Since numerous minute hemispherical lenses 11a are formed on the optical element part 11, the upper end surface of each short pillar 120 comes into contact with a single point on the spherical surface of multiple lenses 11a (point contact). In this way, the short pillars 120 support the lower plate 10D in a state of making point contact with the lenses 11a of the lower plate 10D. Therefore, warping, undulation, or wobbling of the lower plate 10D can be suppressed.

Next, an adhesive is applied to the lower plate 10D (Step S3 in FIG. 9). Specifically, the adhesive is applied to portions of the upper surface of the lower plate 10D other than the optical element part 11. In the embodiment, the adhesive is applied along the entire outer periphery of the lower plate 10D.

In the embodiment, it is assumed that a UV-curable adhesive is used as the adhesive, but the type of adhesive can be changed arbitrarily. However, since some time is needed to align the upper plate 10U with respect to the lower plate 10D (to be described later), it is preferable to use an adhesive (UV-curable, heat-curable, pressure-sensitive, etc.) whose curing (solidification) time is arbitrarily adjustable.

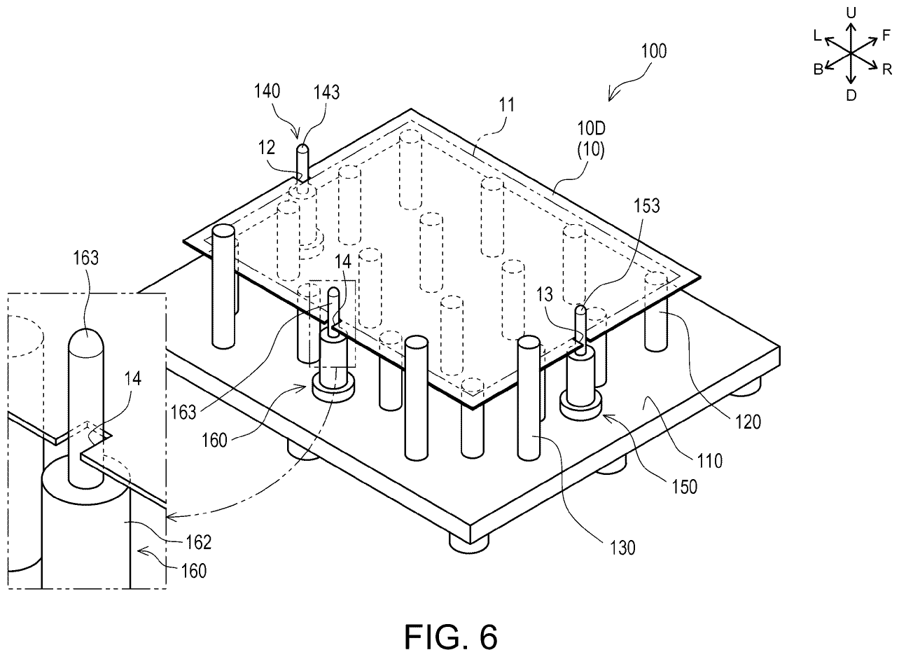

Next, the positioning members are inserted into the respective notch parts of the lower plate 10D (Step S4 in FIG. 9). Specifically, as shown in FIG. 5 and FIG. 6, the first positioning member 140 is placed on the upper surface of the base part 110, and the contact part 143 of the first positioning member 140 is inserted into the left notch part 12 of the lower plate 10D. Since the diameter of the contact part 143 is adjusted to match the actual dimension (width) of the left notch part 12, the contact part 143 makes contact with a single point (point contact) on each of the pair of facing surfaces 12a and 12b located at the front and rear of the left notch part 12. At this time, the position of the first positioning member 140 is adjusted so that the contact part 143 does not contact the end surface (right end surface) at the back of the left notch part 12. With the contact part 143 contacting the pair of facing surfaces 12a and 12b located at the front and rear of the left notch part 12 in this way, relative movement between the first positioning member 140 and the lower plate 10D in the front-rear direction is restricted.

Similarly, the contact part 153 of the second positioning member 150 is inserted into the right notch part 13 of the lower plate 10D. By inserting the second positioning member 150 into the right notch part 13, relative movement between the second positioning member 150 and the lower plate 10D in the front-rear direction is restricted. Additionally, the contact part 163 of the third positioning member 160 is inserted into the rear notch part 14 of the lower plate 10D. By inserting the third positioning member 160 into the rear notch part 14, relative movement between the third positioning member 160 and the lower plate 10D in the left-right direction is restricted.

In this way, by respectively inserting the positioning members into the notch parts (left notch part 12 and right notch part 13, as well as rear notch part 14) formed along two mutually perpendicular directions, it is possible to restrict the horizontal movement of the lower plate 10D (specifically, movement in the front-rear direction and left-right direction) and perform positioning.

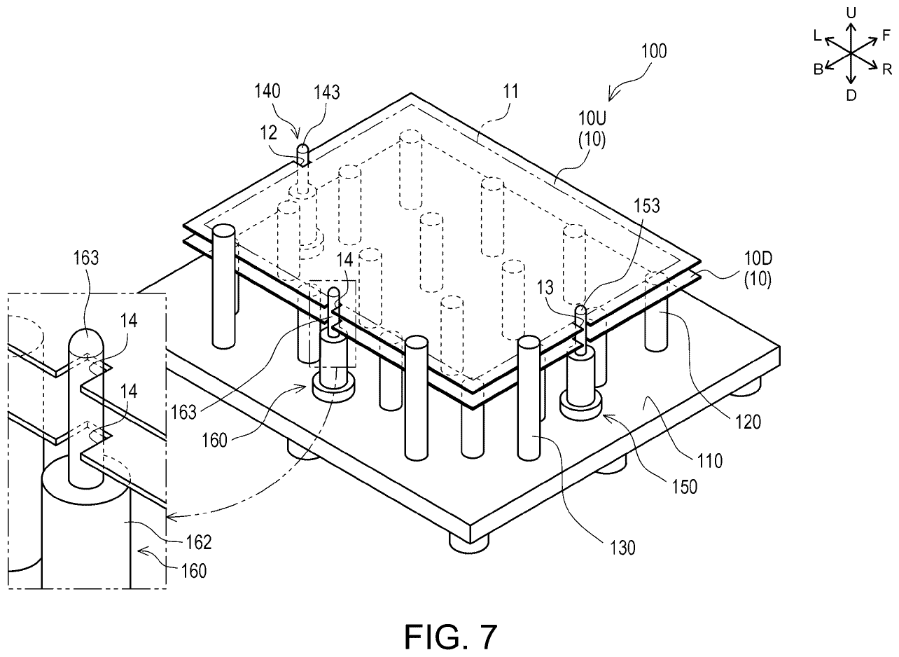

Next, the positioning members are inserted into the respective notch parts of the upper plate 10U (Step SS5 in FIG. 9). Specifically, as shown in FIG. 7, the upper plate 10U is carried above the lower plate 10D. After that, the contact part 143 of the first positioning member 140 is inserted into the left notch part 12 of the upper plate 10U. Similarly, the second positioning member 150 and the third positioning member 160 are inserted into the right notch part 13 and the rear notch part 14 of the upper plate 10U, respectively.

Here, since the upper plate 10U and the lower plate 10D are manufactured by using the same molding part 20 (refer to FIG. 2), the respective notch parts of the upper plate 10U and the lower plate 10D are formed to have the same dimensions. Therefore, similar to the lower plate 10D, the pairs of facing surfaces of the respective notch parts of the upper plate 10U contact the respective positioning members. By inserting the respective positioning members into the respective notch parts of the upper plate 10U and the lower plate 10D in this way, it is possible to align (position) the relative position of the upper plate 10U with respect to the lower plate 10D. In the embodiment, it is possible to align the optical axis of the lens 11a of the upper plate 10U with the optical axis of the lens 11a of the lower plate 10D.

Next, as shown in FIG. 8, the clamp plate 170 is placed on the upper plate 10U (Step S6 in FIG. 9). Furthermore, with the clamp plate 170 placed on the upper plate 10U, the clamp plate 170 and the upper plate 10U are pressed down to bring the upper plate 10U into contact with the lower plate 10D. At this time, the lens 11a formed on the lower surface of the upper plate 10U contacts the lens 11a formed on the upper surface of the lower plate 10D. Also at this time, the adhesive applied to the upper surface of the lower plate 10D adheres to the lower surface of the upper plate 10U.

Next, the adhesive is cured to bond the upper plate 10U and the lower plate 10D (Step S7 in FIG. 9). In the embodiment, the UV-curable adhesive can be cured by irradiating the adhesive with ultraviolet light. Since the clamp plate 170 is placed on the plate 10, in the embodiment, ultraviolet light is irradiated from below the plate 10. As the plate 10 is placed on the short pillars 120, ultraviolet light can be irradiated from below the plate 10 through the gaps between the short pillars 120. At this time, since the plate 10 is pressed down by the clamp plate 170, it is possible to bond the upper plate 10U and the lower plate 10D while correcting any warping or undulation of the plate 10.

It should be noted that the method of irradiating ultraviolet light is not limited to this. For example, the shape, the material, etc., of the clamp plate 170 may be modified, such as forming the clamp plate 170 from a transparent material or making it smaller, so that ultraviolet light can be irradiated from above the plate 10.

In addition, in the embodiment, since a UV-curable adhesive is used, the adhesive is cured by being irradiated with ultraviolet light. However, in the case where other types of adhesives are used, the adhesive can be cured by using methods appropriate for the adhesive.

Next, the clamp plate 170 is removed, and each positioning member is removed (Step S8 in FIG. 9). This allows for obtaining two plates 10 bonded to each other. That is, the optical component 1 can be manufactured. The optical component 1 may be made into a final product by cutting the outline to remove the left notch part 12, the right notch part 13, and the rear notch part 14.

The invention has been described with reference to the embodiment above. However, the invention is not limited to the embodiment described above, and various modifications are possible within the scope of the technical concept of the invention as described in the claims.

For example, in the embodiment, an example of manufacturing the optical component 1 by using the plates 10 that are rectangular is shown. However, the invention is not limited to this, and the shape of the plate 10 can be modified arbitrarily. For instance, it is also possible to manufacture the optical component 1 by using the circular plates 10.

Moreover, in the embodiment, an example of manufacturing the optical component 1 by using the plates 10 with the lenses 11 a formed on both surfaces is shown. However, the invention is not limited to this. For example, it is also possible to manufacture the optical component 1 with the lenses 11a formed on both surfaces by bonding two plates 10 with the lenses 11a formed on only one surface each.

Furthermore, in the embodiment, an example of manufacturing the optical component 1 by using two plates 10 formed in the same shape by using the same molding part 20 is shown. However, the invention is not limited to this. For example, it is possible to manufacture the optical component 1 by using two plates 10 formed in the same shape by using different molding dies 20. Additionally, it is possible to manufacture the optical component 1 by using two plates 10 having mutually different shapes.

In addition, the configuration of the molding part 20 shown in the embodiment is an example, and the configuration of the molding die 20 for manufacturing the plate 10 is not particularly limited. It is possible to divide or integrate each component constituting the molding die 20. For example, in the embodiment, an example of directly forming the molding part 22a on the cavity block 22 is shown. However, it is also possible to prepare a separate member on which the molding part 22a is formed and adopt a configuration where the component is attached to the cavity block 22.

Moreover, in the embodiment, an example of bonding the two plates 10 with adhesive is shown. However, the invention is not limited to this, and it is possible to bond the two plates 10 in various ways. For example, it is possible to bond the plates by laser welding or to join the plates by using fasteners such as screws.

Furthermore, the molding die 20 exemplified in the embodiment is an example, and the configuration of the molding part 20 can be modified arbitrarily.

Additionally, for example, it is possible to execute a process to inspect whether the positions of the two plates 10 are aligned before the adhesive is cured (Step S7 in FIG. 9). As an inspection method, for example, a pattern (such as figures or scale lines) serving as a guide can be provided below the two plates 10 (on the upper surface of the base part 110), and whether the pattern appears distorted is checked when looking down at the two plates 10 from above. In the case of performing such an inspection, it is possible to modify the shape of the clamp plate 170 arbitrarily, such as making it smaller, so as to look down at the plates 10 from above.

Moreover, in the embodiment, an example of manufacturing the optical component 1 by bonding the two plates 10 is shown. However, the invention is not limited to this, and it is possible, for example, to bond three or more plates 10.

Furthermore, in the embodiment, an example of forming three notch parts (left notch part 12, right notch part 13, and rear notch part 14) on the plate 10 is shown. However, the invention is not limited to this. In other words, as long as at least two notch parts are formed along two mutually perpendicular directions, the number and position of the notch parts are not limited.

Moreover, in the embodiment, an example using the short pillars 120 and the long pillars 130 in cylindrically columnar shapes is shown. However, the shape of each pillar is not limited. In other words, the short pillars 120 can have any shape that can support the plate 10. Also, the long pillars 130 can have any shape that can perform positioning of the plate 10.

Furthermore, the method for manufacturing the optical component 1 shown in the embodiment (refer to FIG. 9) is an example, and the procedures and contents can be modified arbitrarily. For instance, in the embodiment, the upper plate 10U is brought into contact with the lower plate 10D by pressing down the clamp plate 170 and the upper plate 10U in the state where the clamp plate 170 is placed on the upper plate 10U (Step S6). However, the upper plate 10U may also be brought into contact with the lower plate 10D at the time point when positioning members are inserted into the respective notch parts of the upper plate 10U (Step S5).

### Second Embodiment

The following describes a method for manufacturing for the optical component 1 (bonding method of the two plates 10) according to the second embodiment.

In the method for manufacturing the optical component 1 according to the second embodiment, as shown in FIG. 10 and FIG. 11, the plate 10 with a first convex part 15 and a second convex part 16 formed is used. The following describes the plate 10 according to the second embodiment.

The main difference between the plate 10 according to the second embodiment and the plate 10 according to the first embodiment (see FIG. 1, etc. ,) is that the first convex part 15 and the second convex part 16 are formed on the plate 10 according to the second embodiment. Therefore, the following mainly describes the first convex part 15 and the second convex part 16. For structures similar to the plate 10 according to the first embodiment (refer to FIG. 1, etc.), the same reference numerals are used and explanations are omitted as appropriate.

The first convex part 15 is a portion formed to protrude from the surface of the plate 10. The first convex part 15 is formed in an annular shape surrounding the optical element part 11 from the outer side. The first convex part 15 is formed in a rectangular shape slightly larger than the optical element part 11. The first convex part 15 is formed gaplessly around the entire periphery of the optical element part 11. In other words, the first convex part 15 is formed to be continuously connected on the outer side of the optical element part 11. The first convex part 15 is formed to pass through the inner side of the notch parts (left notch part 12, right notch part 13, and rear notch part 14) formed on the plate 10. The height of the first convex part 15 is formed to be approximately the same as the height of the optical element part 11 (strictly speaking, slightly lower than the height of the optical element part 11). The first convex part 15 is formed on both surfaces of the plate 10.

The second convex part 16 is a portion formed to protrude from the surface of the plate 10. The second convex part 16 is formed on the outer side of the first convex part 15. The height of the second convex part 16 is formed to be approximately the same as the height of the optical element part 11 (strictly speaking, slightly lower than the height of the optical element part 11). The second convex part 16 mainly includes a notch side convex part 16a and an outer peripheral side convex part 16b.

The notch side convex part 16a is formed around the notch parts (left notch part 12, right notch part 13, and rear notch part 14) formed on the plate 10. Specifically, the notch side convex part 16a is formed to follow along a pair of surfaces (facing surfaces) of the notch parts. For example, referring on the right notch part 13 shown in (a) of FIG. 11, the notch side convex part 16a is formed to extend in the left-right direction along a pair of surfaces (facing surfaces) 13a and 13b that face each other at the front and rear of the right notch part 13. Furthermore, the right end of the notch side convex part 16a is formed to extend in the front-rear direction along the right end surface of the plate 10. In this way, the notch side convex part 16a is formed in an approximately L-shape along the notch part and the end surface of the plate 10.

The outer peripheral side convex part 16b is formed along the end surface of the plate 10. Specifically, the outer peripheral side convex part 16b is formed to follow along the front, rear, left, and right end surfaces of the rectangular-shaped plate 10. The outer peripheral side convex part 16b is formed to be partially discontinuous. Specifically, as shown in FIG. 10 and FIG. 11, a gap is provided between the outer peripheral side convex part 16b and the notch side convex part 16a. Accordingly, a notch part N is formed. Additionally, the notch part N are also formed near the corners (near the vertices) of the rectangular-shaped plate 10. Furthermore, the notch parts N are formed at locations as appropriate.

The first convex part 15 and the second convex part 16 are formed on the upper and lower surfaces of the plate 10, respectively. Since the upper and lower surfaces of the plate 10 are formed in the same shape, it is also possible to use the plate 10 in an orientation inverted in the upper-lower direction.

Next, the specific procedure for manufacturing the optical component 1 according to the second embodiment will be described. The method for manufacturing the optical component 1 according to the second embodiment is basically similar to that of the first embodiment (see FIG. 9, etc.). Therefore, in the following, the description will mainly focus on the difference from the first embodiment, and the description of the points similar to the first embodiment will be omitted as appropriate.

In the second embodiment, in the case where an adhesive is applied to the lower plate 10D (Step S3 in FIG. 9), an adhesive G is applied to the outer side of the first convex part 15, as shown in FIG. 12. In FIG. 12, the adhesive G applied to the lower plate 10D is indicated by hatching.

At this time, the first convex part 15 and the second convex part 16 can be used as guides at the time of applying the adhesive G. Specifically, by moving a tool (e.g., a syringe) used for applying the adhesive G along the first convex part 15 and the second convex part 16, the application process can be easily performed.

Additionally, by comparing the height of the first convex part 15 and the second convex part 16 with the height of the adhesive G applied to the lower plate 10D, it is possible to grasp the coating amount of the adhesive G, so the coating amount of the adhesive G can be easily adjusted.

Furthermore, the first convex part 15 formed around the optical element part 11 can prevent the adhesive G from flowing toward the side of the optical element part 11. Accordingly, the occurrence of a defective product can be prevented. Additionally, the notch side convex part 16a formed around the notch part (such as the right notch part 13) can prevent the adhesive G from flowing out into the right notch part 13, etc. Accordingly, the adhesive G can be prevented from adhering to the positioning members (the first positioning member 140, the second positioning member 150, and the third positioning member 160) and a decrease in positioning accuracy can be prevented.

After the adhesive G is applied, the positioning members are inserted into grooves (the respective notch parts) of the upper plate 10U and the grooves (the respective notch parts) of the lower plate 10D (Steps S4 and S5 in FIG. 9). Then, the clamp plate 170 is placed on the upper plate 10U (Step S6 in FIG. 9), and the upper plate 10U is brought into contact with the lower plate 10D. Accordingly, the lens 11a formed on the lower surface of the upper plate 10U comes into contact with the lens 11a formed on the upper surface of the lower plate 10D.

At this time, the first convex parts 15 formed on the upper plate 10U and the lower plate 10D are arranged to face each other in the upper-lower direction. Additionally, the second convex parts 16 formed on the upper plate 10U and the lower plate 10D are arranged to face each other in the upper-lower direction (refer to (b) of FIG. 12). By arranging not only the first convex part 15 formed on the inner side of the plate 10 but also the second convex part 16 formed on the outer side of the plate 10 to face each other in the upper-lower direction, it is possible to prevent the two plates 10 from tilting relative to each other.

At the time of bringing the upper plate 10U into contact with the lower plate 10D, the adhesive G applied to the lower plate 10D is spread out between the upper plate 10U and the lower plate 10D. Accordingly, the adhesive G can be applied over a wide range around the optical element part 11, thereby preventing the occurrence of uneven adhesion.

At this time, the first convex parts 15 formed on the upper plate 10U and the lower plate 10D can prevent the adhesive G from flowing toward the side of the optical element part 11. Additionally, by using the notch side convex parts 16a, the adhesive G can be prevented from flowing out toward the notch parts (such as the right notch part 13, etc.).

Furthermore, with the outer peripheral side convex parts 16b formed on the upper plate 10U and the lower plate 10D, the adhesive G can be prevented from flowing out to the outer side of the plate 10. Accordingly, the adhesive G can be spread within the plate 10, so the adhesive G can be efficiently applied to the plate 10. Moreover, with the notch part N formed in the outer peripheral side convex part 16b, excessively applied adhesive G can escape. Therefore, the adhesive G can be effectively prevented from flowing toward the side of the optical element part 11.

As described above, the plate 10 according to the second embodiment can prevent the occurrence of a defect in the optical component 1 by limiting the flow of the adhesive G with the first convex part 15 and the second convex part 16.

The upper plate 10U and the lower plate 10D according to the second embodiment are formed to have the same shape. Therefore, as in the first embodiment, the upper plate 10U and the lower plate 10D can be manufactured by using the same molding die 20. Accordingly, the initial investment required to manufacture the optical component 1 can be reduced.

In addition, since the upper and lower surfaces of the plate 10 are in the same shape, it is also possible to use the plate 10 in an orientation inverted in the upper-lower direction. Therefore, for example, in the case where warping occurs after the plate 10 is molded, the quality of the optical component 1 can be maintained and improved by using the plate 10 in any orientation according to the direction of warping.

The invention has been described with reference to the second embodiment above. However, the invention is not limited to the embodiment described above, and various modifications are possible within the scope of the technical concept of the invention as described in the claims. In addition to the appropriate modifications in the first embodiment, the following modified examples are possible.

In the second embodiment, an example is shown where the heights of the first convex part 15 and the second convex part 16 are formed to be substantially the same as the height of the optical element part 11. However, as shown in the first modified example in (a) of FIG. 13, it is also possible to form the heights of the first convex part 15 and the second convex part 16 to be lower than the height of the optical element part 11. In such case, when the upper plate 10U is placed on the lower plate 10D, the lens 11a of the upper plate 10U contacts the lens 11a of the lower plate 10D. As a result, a gap P1 is formed between the first convex part 15 and the second convex part 16 facing each other in the upper-lower direction. It is preferable that the gap P1 is set to be small enough to prevent the adhesive G from flowing through.

Additionally, as shown in the second modified example in (b) of FIG. 13, it is also possible to form the heights of the first convex part 15 and the second convex part 16 to be higher than the height of the optical element part 11. In such case, when the upper plate 10U is placed on the lower plate 10D, the first convex parts 15 and the second convex parts 16 facing each other in the upper-lower direction come into contact with each other. As a result, a gap P2 is formed between the lenses 11a facing each other in the upper-lower direction. For example, if it is necessary to ensure the gap P2 between the lenses 11a in the design of the optical component 1, the gap P2 between the lenses 11a can be easily secured by setting the heights of the first convex part 15 and the second convex part 16 according to the gap P2, as shown in the example in (b) of FIG. 13.

Furthermore, in the second embodiment, an example is shown where the upper plate 10U and the lower plate 10D are formed in the same shape. However, the invention is not limited to this, and it is possible to form the upper plate 10U and the lower plate 10D in different shapes. For example, as shown in the third modified example in (c) of FIG. 13, it is possible to form the first convex part 15 and the second convex part 16 on only one of the two plates 10 ((c) in FIG. 13, only in the lower plate 10D). While not shown, it is also possible to form the first convex part 15 on one of the plates 10 and the second convex part 16 on the other plate 10.

In addition, in the second embodiment, an example is shown where the first convex part 15 and the second convex part 16 are formed on both surfaces of the plate 10. However, the invention is not limited to this. For example, as shown in the lower plate 10D of the third modified example in (c) of FIG. 13, it is possible to form the first convex part 15, etc., only on one surface (upper surface) of the lower plate 10D.

Moreover, the shapes and arrangements of the first convex part 15 and the second convex part 16 exemplified in the second embodiment (see FIG. 10, etc.) are just examples and can be modified arbitrarily. However, from the perspective of preventing the adhesive G from flowing into the optical element part 11, it is desirable that the first convex part 15 is formed to be continuously connected along the entire periphery of the optical element part 11.

Additionally, the first convex part 15 and the second convex part 16 may be formed on at least one of the upper plate 10U and the lower plate 10D. Moreover, the second convex part 16 does not necessarily need to be formed on the plate 10.

### Third Embodiment

The following describes a method for manufacturing the optical component 1 according to the third embodiment.

In the method for manufacturing the optical component 1 according to the third embodiment, as shown in FIG. 14, the plate 10 with the first convex part 15 and the second convex part 16 formed is used, similar to the second embodiment. The method manufacturing for the optical component 1 according to the third embodiment differs from the first and second embodiments in that, in the third embodiment, the plates 10 are bonded by using laser welding instead of using an adhesive. Therefore, in the following, the processes (steps) that differ from the method manufacturing for the optical component 1 according to the first embodiment (see FIG. 9), and omit the description for other processes as appropriate.

In the third embodiment, after placing the lower plate 10D on the assembly jig 100 (Step S2 in FIG. 15), the positioning members are respectively inserted into the respective notch parts of the lower plate 10D without applying adhesive to the lower plate 10D (Step S4 in FIG. 15). Subsequently, the positioning members are inserted into the respective notch parts of the upper plate 10U (Step SS5 in FIG. 15), and the clamp plate 170 is placed on the upper plate 10U (Step S6 in FIG. 15).

Here, in the third embodiment, the plates 10 are bonded by laser irradiated from above (see (b) of FIG. 14). Therefore, in the third embodiment, the clamp plate 170 formed by a light-transmitting material (for example, glass, etc.) is used to avoid the laser irradiated from above from being obstructed. However, in the case where the clamp plate 170 is disposed at a position so as not to obstruct the laser irradiated from above, or in the case where the laser is irradiated to the plates 10 from below, it is not necessarily required to use a light-transmitting clamp plate 170.

Then, as shown in (b) of FIG. 14, laser is irradiated from above to perform laser welding on the upper plate 10U and the lower plate 10D (Step S17 in FIG. 15). In the case of laser welding, as shown in FIG. 14, by irradiating the laser along the first convex part 15 and the second convex part 16, the first convex part 15, etc., formed on the upper plate 10U and the first convex part 15, etc., formed on the lower plate 10D are welded together. In (a) of FIG. 14, an example of the laser irradiation position is indicated by a broken line W. In this way, by welding the first convex part 15 and the second convex part 16 arranged to face each other in the upper-lower direction, the upper plate 10U and the lower plate 10D can be bonded together.

Here, in the third embodiment, laser with a long wavelength (for example, laser with a wavelength of 2 μm) is used. By using the laser with a long wavelength, the laser light can be absorbed by the transparent plates 10, and welding can be performed. In the case of using laser with a short wavelength (for example, laser with a wavelength of 1 μm), it is possible to weld the plates 10 by, for example, applying a light-absorbing material such as carbon to the welding portions (the surfaces where the first convex parts 15 and the second convex parts 16 face each other) in advance.

Next, the clamp plate 170 is removed, and each positioning member is removed (Step S8 in FIG. 15). This allows for obtaining two plates 10 bonded to each other. That is, the optical component 1 can be manufactured.

As described above, in the third embodiment, since the plates 10 are bonded by laser welding, unlike the case of using an adhesive, it is possible to prevent the adhesive from flowing into the optical element part 11 or prevent uneven adhesion from occurring. Additionally, since there is no need for the time to cure the adhesive, the manufacturing time of the optical component 1 can be reduced. Furthermore, there is no risk of the plates 10 separating due to degradation of the adhesive.

In particular, in the third embodiment, since the first convex parts 15 are laser-welded to each other, the plates 10 can be uniformly bonded at positions closer to the optical element part 11 than the case in the second embodiment. Accordingly, a high-precision optical component 1 can be manufactured. Furthermore, in the third embodiment, since the notch side convex parts 16a are laser-welded to each other, the plates 10 can be uniformly bonded at positions closer to the right notch part 13 etc., than the case in the second embodiment. This allows for positioning of the plates 10 at higher precision.

Moreover, in the third embodiment, not only the first convex parts 15 but also the second convex parts 16 (such as the outer peripheral side convex parts 16b) are laser-welded to each other. Therefore, the plates 10 can be bonded more firmly. Additionally, by providing the notch part N in the outer peripheral side convex part 16b, the heat at the time of performing laser welding can be dissipated to the outside of the plates 10, and the occurrence of abnormalities (such as deformation) in the plates 10 can be suppressed.

The invention has been described with reference to the third embodiment above. However, the invention is not limited to the embodiment described above, and various modifications are possible within the scope of the technical concept of the invention as described in the claims. In addition to the appropriate modifications in the first and second embodiments, the following modified examples are possible.

In the third embodiment, an example is shown where the plates 10 formed with the first convex parts 15 and the second convex parts 16 similar to those of the second embodiment are used, and the convex parts are laser-welded to each other. However, the invention is not limited to this. In other words, the invention does not limit the shape or arrangement of the convex parts, as long as the plates 10 can be bonded to each other.

For example, in the example shown in FIG. 14, the first convex part 15 surrounding the optical element part 11 and the second convex part 16 arranged on the outer side of the first convex part 15 are shown. However, as shown in the fourth modified example in (a) of FIG. 16, it is also possible to form only a convex part 17 surrounding the optical element part 11 on the plate 10.

Furthermore, while the fourth modified example shown in (a) of FIG. 16 illustrates the convex part 17 formed to continuously connect around the entire periphery of the optical element part 11, it is also possible to form discontinuous convex parts 18 on the plate 10, as shown in the fifth modified example in (b) of FIG. 16.

Additionally, for the third embodiment, like the second embodiment, the shape of the plate 10 (the height of the convex parts, the presence or absence of the convex part on each plate 10, etc.) can be arbitrarily modified (see FIG. 13).

### Appendices

The method for manufacturing the optical component 1 according to the first aspect of the disclosure is a method for manufacturing the optical component 1 by bonding two or more plates. The plate has an optical element part. The method includes: a first positioning step (Step S4 in FIG. 9) for causing a positioning member (the first positioning member 140, the second positioning member 150, and the third positioning member 160) to come into contact with a pair of facing surfaces of each first notch part of a first plate (the lower plate 10D), which face each other, the first plate having at least two first notch parts (the left notch part 12 and the right notch part 13, as well as the rear notch part 14) formed along two directions orthogonal to each other; a second positioning step (Step 5 of FIG. 9) for causing the alignment member to come into contact with a pair of facing surfaces of each second notch part of a second plate (the upper plate 10U), which face each other, the second plate having at least two second notch parts (the left notch part 12 and the right notch part 13, as well as the rear notch part 14) formed along two directions orthogonal to each other; and a bonding step (Step S7 of FIG. 9) for bonding the first plate and the second plate.
According to the method for manufacturing the optical component 1 of the first aspect of the disclosure, precise alignment between the plates 10 can be achieved. That is, by bringing the positioning member to come into contact with the pairs of facing surfaces of the notch parts formed in the two plates 10, relative positioning of the two plates 10 can be carried out. Additionally, since positioning can be performed relatively easily, the workload can be reduced.

The method for manufacturing the optical component 1 of the second aspect following the first aspect includes: a placing step (Step S2 in FIG. 9) for placing the first plate on multiple first pillars (the short pillars 120) before the first positioning step.

According to the method for manufacturing the optical component 1 of the second aspect of the disclosure, it is possible to secure a space below the first plate (gaps of the short pillars 120). Accordingly, UV light can be irradiated from below or the plate 10 can be inspected, so the can be improved.

In the method for manufacturing the optical component 1 of the third aspect following the second aspect, the optical element part includes multiple lenses 11a formed on a lower surface of the first plate, and in the placing step, the first plate is disposed so that the lenses 11a and the first pillars come into contact with each other.

According to the method form manufacturing the optical component 1 of the third aspect of the disclosure, since the first pillars come into contact (point contact) with a single point on the spherical surfaces of the lenses 11a, it is possible to suppress warping, undulation, and rattling of the first plate.

In the method for manufacturing the optical component 1 of the fourth aspect following the second or third aspect, in the placing step, the first plate is disposed so that an end surface contacts a second pillar (the long pillar 130) differing from the first pillar.

According to the method for manufacturing the optical component 1 of the fourth aspect of the disclosure, rough positioning of the first plate can be performed by using the second pillars. Accordingly, the first plate to be positioned in a correct location, and the workability can be improved.

The method for manufacturing the optical component 1 of the fifth aspect following any one of the second to fourth aspects includes: a weight placing step (Step S6 of FIG. 9) for placing a weight (the clamp plate 170) on the first plate and the second plate after the second positioning step and before the bonding step.

According to the method for manufacturing the optical component 1 of the fifth aspect of the disclosure, it is possible to correct warping and undulation of the plates 10.

In the method for manufacturing the optical component 1 of the sixth aspect following any one of the first to fifth aspects, the optical element part 11 includes multiple lenses 11a respectively formed on both surfaces of the plate 10.

According to the method for manufacturing the optical component 1 of the sixth aspect of the disclosure, precise alignment between the plates 10 in which the lenses 11a are formed on both surfaces can be achieved.

In the method for manufacturing the optical component 1 of the seventh aspect following the sixth aspect, the first notch parts and the lenses 11a of the first plate and the second notch parts and the lenses 11a of the second plate are formed through resin molding using a same molding die 20.

According to the method for manufacturing the optical component 1 of the seventh aspect of the disclosure, by manufacturing two plates 10 by using the same molding die 20, it is possible to make the dimensions of both plates identical, enabling high-accuracy alignment between the plates 10. Additionally, since the relative positional relationship between the lenses 11a and the respective notch parts becomes constant, it is possible to accurately align the optical axes of the lenses 11a of the plates 10.

In the method for manufacturing the optical component 1 of the eighth aspect following any one of the first to seventh aspects, at least one of the first plate and the second plate has a first convex part 15 having an annular shape and formed to surround the optical element part 11 from an outer side, and in the bonding step (Step S7 of FIG. 9), the first plate and the second plate are bonded by using an adhesive coated on an outer side of the first convex part 15.

According to the method for manufacturing the optical component 1 of the eighth aspect of the disclosure, it is possible to prevent the adhesive from flowing into the optical element part 11.

In the method for manufacturing the optical component 1 according to the ninth aspect following the eighth aspect, at least one of the first plate and the second plate has a second convex part 16 formed on the outer side of the first convex part 15.

According to the method for manufacturing the optical component 1 of the ninth aspect of the disclosure, it is possible to prevent the occurrence of a defect in the optical component 1 by limiting the flow of the adhesive by using the second convex part 16. In addition, by forming the second convex part 16 in addition to the first convex part 15, it is possible to prevent the two plates 10 from tilting relative to each other.

In the method for manufacturing the optical component 1 according to the tenth aspect following the ninth aspect, the second convex part 16 includes notch side convex parts 16a formed around the first notch parts and the second notch parts.

According to the method for manufacturing the optical component 1 of the tenth aspect of the disclosure, it is possible to prevent adhesion of the adhesive G to the positioning members (the first positioning member 140, the second positioning member 150, and the third positioning member 160), and to prevent a decrease in positioning accuracy.

In the method for manufacturing the optical component 1 of the eleventh aspect following any one of the first to seventh aspects of the disclosure, the first plate and the second plate have welding convex parts (the first convex part 15 and the second convex part 16) formed on outer sides of the optical element parts 11, and in the bonding step (Step S17 of FIG. 15), the welding convex part formed in the first plate and the welding convex part formed in the second plate are laser-welded.

According to the method for manufacturing the optical component 1 of the eleventh aspect of the disclosure, unlike the case of using an adhesive, it is possible to prevent the adhesive from flowing into the optical element part 11 or causing uneven adhesion. Additionally, since there is no need for the time to cure the adhesive, the manufacturing time of the optical component 1 can be reduced.

### REFERENCE SIGNS LIST

1: Optical component;
10: Plate;
10D: Lower plate (first plate);
10U: Upper plate (second plate);
11: Optical element part;
11a: Lens;
12: Left notch part;
13: Right notch part;
14: Rear notch part;
15: First convex part;
16: Second convex part;
16a: Notch side convex part;
16b: Outer peripheral side convex part;
20: Molding die;
100: Assembly jig;
120: Short pillar;
130: Long pillar;
140: First positioning member;
150: Second positioning member;
160: Third positioning member;
170: Clamp plate.

1. A method for manufacturing an optical component, the method being provided to manufacture the optical component by bonding two or more plates, the plate having an optical element part, wherein the method comprises:
causing a positioning member to come into contact with a pair of facing surfaces of each first notch part of a first plate, which face each other, the first plate having at least two first notch parts formed along two directions orthogonal to each other;
causing the positioning member to come into contact with a pair of facing surfaces of each second notch part of a second plate, which face each other, the second plate having at least two second notch parts formed along two directions orthogonal to each other; and
bonding the first plate and the second plate.

2. The method for manufacturing the optical component as claimed in claim 1, comprising placing the first plate on a plurality of first pillars before causing the positioning member to come into contact with the pair of facing surfaces of each first notch part of the first plate

3. The method for manufacturing the optical component as claimed in claim 2, wherein the optical element part comprises a plurality of lenses formed on a lower surface of the first plate, and
during placing of the first plate on the first pillars, the first plate is disposed so that the lenses and the first pillars come into contact with each other.

4. The method for manufacturing the optical component as claimed in claim 2, wherein, during placing of the first plate on the first pillars, the first plate is disposed so that an end surface contacts a second pillar differing from the first pillar.

5. The method for manufacturing the optical component as claimed in claim 1, comprising placing a weight on the first plate and the second plate after causing the positioning member to come into contact with the pair of facing surfaces of each second notch part of the second plate and before bonding the first plate and the second plate.

6. The method for manufacturing the optical component as claimed in claim 1, wherein the optical element part comprises a plurality of lenses respectively formed on both surfaces of the plate.

7. The method for manufacturing the optical component as claimed in claim 6, wherein the first notch parts and the lenses of the first plate and the second notch parts and the lenses of the second plate are formed through resin molding using a same molding die.

8. The method for manufacturing the optical component as claimed in claim 1, wherein at least one of the first plate and the second plate has a first convex part having an annular shape and formed to surround the optical element part from an outer side, and
during bonding of the first plate and the second plate, the first plate and the second plate are bonded by using an adhesive coated on an outer side of the first convex part.

9. The method for manufacturing the optical component as claimed in claim 8, wherein at least one of the first plate and the second plate has a second convex part formed on the outer side of the first convex part.

10. The method for manufacturing the optical component as claimed in claim 9, wherein the second convex part comprises notch side convex parts formed around the first notch parts and the second notch parts.

11. The method for manufacturing the optical component as claimed in claim 1, wherein the first plate and the second plate have welding convex parts formed on outer sides of the optical element parts, and
during bonding of the first plate and the second plate, the welding convex part formed in the first plate and the welding convex part formed in the second plate are laser-welded.
